(19) United States
(12) Patent Application Publication
(10) Pub. No.: US 2026/0062866 A1
(43) Pub. Date: Mar. 5, 2026

(54) CREPING ADHESIVE COMPOSITION

(71) Applicants: SOLENIS TECHNOLOGIES, L.P., Wilmington, DE (US); Solenis (Shanghai) Chemicals Co., Ltd., Shanghai (CN)

(72) Inventors: Yanru Fan, Shanghai (CN); Nicolas Ince, Shanghai (CN)

(73) Assignees: SOLENIS TECHNOLOGIES, L.P., Wilmington, DE (US); Solenis (Shanghai) Chemicals Co., Ltd., Shanghai (CN)

(21) Appl. No.: 19/314,128

(22) Filed: Aug. 29, 2025

Related U.S. Application Data
(60) Provisional application No. 63/688,371, filed on Aug. 29, 2024.

(51) Int. Cl. D21H 21/14; C09J 11/06; C09J 11/08; C09J 177/04; C09J 179/02

(52) U.S. Cl. CPC D21H 21/146; C09J 11/06; C09J 11/08; C09J 177/04; C09J 179/02

(57) ABSTRACT

A creping adhesive composition includes an adhesive polymer chosen from a polyacrylamide, a specific polyamine, and combinations thereof that is present in an amount of from about 1 to about 45 wt % actives, based on a total weight of the composition; a film modifier including a polyvinylamine that is present in an amount of from about 0.1 to about 40 wt % actives, based on a total weight of the composition; and a plasticizer including a compound having two or more —OH groups that is present in an amount of from about 0.1 to about 40 wt % actives, based on a total weight of the composition; wherein the composition is free of polyamidoamine-epihalohydrin (PAE) and polyethyleneimine (PEI).

### CROSS-REFERENCE TO RELATED APPLICATIONS

This application claims the benefit of U.S. Provisional Application No. 63/688,371 filed Aug. 29, 2024, the entirety of which is expressly incorporated herein by reference.

### TECHNICAL FIELD

The present disclosure generally relates to a creping adhesive composition that is free of polyamidoamine-epihalohydrin (PAE) and polyethyleneimine (PEI). More specifically, the creping adhesive composition includes an adhesive polymer chosen from a polyacrylamide, a particular polyamine, and combinations thereof; a film modifier including a polyvinylamine; and a plasticizer including a compound having two or more —OH groups.

### BACKGROUND

Creping adhesives are typically used in paper-making processes, e.g. manufacturing of tissue papers, paper towels, etc. For example, creping adhesives can be applied onto surfaces of paper-making equipment, e.g. as a thin film onto the surface of a creping dryer such as a Yankee dryer, to help the drying and releasing of paper products.

More specifically, the use of creping adhesives can help to control adhesion between fibrous webs of paper products and the surface of the creping dryer. This control is beneficial for maintaining an efficient production process and reducing wear of the equipment.

Additionally, creping adhesives are used for various other purposes, such as customization of adhesive film properties, e.g. dry tackiness, wet tackiness, softness, etc. and enhancing paper performance, e.g. absorbency, paper strength, uniformity, etc.

Conventional creping adhesives typically include adhesive polymers such as polyamidoamine-epihalohydrin (PAE) and/or polyethyleneimine (PEI). However, various factors such as increasing use of recycled paper materials, development of new creping dryers, etc. have prompted the search for alternative adhesive polymers and formulations that can be effectively used in paper-making processes.

Accordingly, there is an opportunity for the development of new creping adhesives.

### BRIEF SUMMARY

This disclosure provides a creping adhesive including an adhesive polymer chosen from a polyacrylamide, a polyamine, and combinations thereof that is present in an amount of from about 1 to about 45 wt % actives, based on a total weight of the composition; a film modifier including a polyvinylamine that is different from the polyamine of the adhesive polymer and is present in an amount of from about 0.1 to 40 wt % actives, based on a total weight of the composition; and a plasticizer including a compound having two or more —OH groups that is present in an amount of from about 0.1 to 40 wt % actives, based on a total weight of the composition; wherein the polyamine is the reaction product of epichlorohydrin, dimethylamine, and ethylenediamine, and wherein the composition is free of polyamidoamine-epihalohydrin (PAE) and polyethyleneimine (PEI).

The disclosure additionally provides a method of forming the creping adhesive composition. The method includes the steps of a) providing the adhesive polymer; b) providing the film modifier; c) providing the plasticizer; and c) combining the adhesive polymer, the film modifier and the plasticizer to form the creping adhesive composition such that the adhesive polymer is present in an amount of from about 1 to about 45 wt % actives, the film modifier is present in an amount of from about 0.1 to about 40 wt % actives, and the plasticizes is present in an amount of from about 0.1 to about 40 wt % actives, each based on a total weight of the composition.

The disclosure also provides a method of creping a fibrous web. The method includes the steps of a) providing a creping dryer including a creping cylinder that has a surface; b) providing a fibrous web; c) providing the creping adhesive composition; d) applying the creping adhesive composition to the surface of the creping cylinder; e) contacting the fibrous web and the surface of the creping cylinder; and f) removing the fibrous web from the surface of the creping cylinder with a doctor blade to crepe the fibrous web.

### BRIEF DESCRIPTION OF THE DRAWINGS

The present disclosure will hereinafter be described in conjunction with the following drawing figures, wherein like numerals denote like elements, and

FIG. 1 is a side perspective view of an embodiment of a peel test apparatus used to test the peel strength of the composition; and

FIG. 2 is a side perspective view of an embodiment of a Yankee dryer used to apply the composition and crepe fibrous webs to form paper products.

### DETAILED DESCRIPTION

The following detailed description is merely exemplary in nature and is not intended to limit the current composition. Furthermore, there is no intention to be bound by any theory presented in the preceding background or the following detailed description.

Embodiments of the present disclosure are generally directed to polymers, compositions including the same, and methods for forming the same. For the sake of brevity, conventional techniques related to making polymers and such compositions may not be described in detail herein. Moreover, the various tasks and process steps described herein may be incorporated into a more comprehensive procedure or process having additional steps or functionality not described in detail herein. In particular, various steps in the manufacture of polymers and associated compositions are well-known and so, in the interest of brevity, many conventional steps will only be described briefly herein or will be omitted entirely without providing the well-known process details.

In this disclosure, the terminology “about” can describe values ±0.1, 0.5, 1, 2, 3, 4, 5, 6, 7, 8, 9, or 10%, in various embodiments. Moreover, it is contemplated that, in various non-limiting embodiments, it is to be appreciated that all numerical values as provided herein, save for the actual examples, are approximate values with endpoints or particular values intended to be read as “about” or “approximately” the value as recited. It is also contemplated that all isomers and chiral options for each compound described herein are hereby expressly contemplated for use herein in various non-limiting embodiments.

Throughout this disclosure, the terminology percent “actives” is well recognized in the art and means the percent amount of active or actual compound or molecule present as compared to, for example, a total weight of a diluted solution of a solvent and such a compound. Some compounds, such as a solvent, are not described relative to a percent actives because it is well known to be approximately 100% actives. Any one or more of the values describe herein may be alternatively described as percent actives as would be understood by the skilled person.

In various embodiments, the terminology “free of” describes embodiments that include less than about 5, 4, 3, 2, 1, 0.5, or 0.1, weight percent (or weight percent actives) of the compound or element at issue using an appropriate weight basis as would be understood by one of skill in the art. In other embodiments, the terminology “free of” describes embodiments that have zero weight percent of the compound or element at issue.

The terminology “consists essentially of” may describe various non-limiting embodiments that are free of one or more optional compounds described herein and/or free of one or more polymers, surfactants, additives, solvents, etc.

It is to be understood that the subscripts of polymers are typically described as average values because the synthesis of polymers typically produces a distribution of various individual molecules.

The polymers and compositions disclosed herein may suitably comprise, consist of, or consist essentially of the components, elements, and process delineations described herein. The embodiments illustratively disclosed herein suitably may be practiced in the absence of any element which is not specifically disclosed herein.

### Creping Adhesive Composition

The disclosure provides a creping adhesive composition that includes an adhesive polymer, a film modifier, and a plasticizer. The creping adhesive composition may be described herein simply as the “composition”. The composition may also be described as an adhesive, a creping adhesive, a coating adhesive, a dryer adhesive, a paper additive, a paper release agent, a Yankee coating composition, etc. The composition may be used for various purposes, e.g. for creping dryer surface management, as a creping dryer modifier or releaser, and/or for customizing adhesive film properties. In various embodiments, the composition is a concentrate. In other embodiments, the composition is a ready-to-use solution, and/or a coating spray. In other embodiments, the composition is dried on a heated surface and is a thin film.

The composition is free of polyamidoamine-epihalohydrin (PAE) and polyethyleneimine (PEI). As first described above, the terminology “free of” may describe embodiments that include less than about 5, 4, 3, 2, 1, 0.5, or 0.1 wt % or wt % actives of the compound or element at issue. Accordingly, in various embodiments, the composition includes less than about 5, 4, 3, 2, 1, 0.5, or 0.1 wt % actives of PAE and less than about 5, 4, 3, 2, 1, 0.5, or 0.1 wt % actives of PEI, based on a total weight of the composition. In various other embodiments, the composition includes about 0 wt % actives of PAE and less than 5, 4, 3, 2, 1, 0.5, or 0.1 wt % actives of PEI. In other embodiments, the composition includes about 0 wt % actives of PEI and less than 5, 4, 3, 2, 1, 0.5, or 0.1 wt % actives of PAE. In yet other embodiments, the composition includes about 0 wt % actives of PAE and about 0% actives of PEI. In various non-limiting embodiments, all values and ranges of values including and between those set forth above are expressly contemplated for use herein.

### Adhesive Polymer

The composition includes the adhesive polymer chosen from a polyacrylamide, a polyamine, and combinations thereof. The adhesive polymer may be or include a polyacrylamide. The polyacrylamide may be a homopolymer or a copolymer, modified or unmodified, linear or branched, cationic, anionic or non-ionic. The polyacrylamide polymer may have a repeating unit that has from 2 to 20 carbon atoms, e.g. 2, 3, 4, 5, 6, 7, 8, 9, 10, 11, 12, 13, 14, 15, 16, 17, 18, 19, or 20 carbon atoms, or from 2 to 15, 3 to 10, 2 to 10, 3 to 15, 2 to 5 carbon atoms, etc. In various non-limiting embodiments, all values and ranges of values including and between those set forth above are expressly contemplated for use herein.

The repeating unit of the polyacrylamide is not particularly limited and may be any known in the art, so long as at least one repeating group is or includes an acrylamide residue. The repeating unit may additionally and optionally include an aromatic group or an aliphatic group. The repeating unit may additionally and optionally include a group that is substituted with various elements e.g. N, S, P, O, a halogen, etc. In various embodiments, the polyacrylamide polymer has one repeating unit that is acrylamide.

In other embodiments, the polyacrylamide polymer has two or more repeating units wherein at least one repeating unit is or include an acrylamide residue, and also has one or more repeating units that is a cationic group to form a cationic polyacrylamide (CPAM). Non-limiting examples of cationic groups include diallyldimethylammonium, dimethylaminoethyl acrylate, dimethylaminoethyl methacrylate, acryloyloxyethyl trimethylammonium, methacryloyloxyethyl trimethylammonium, etc. The cationic group may be charge-balanced with a negatively charged counter ion, e.g. chloride, bromide, iodide, hydroxide, carbonate, sulfate, etc. In various embodiments, the adhesive polymer is or includes a CPAM that is poly (acrylamide-co-diallyldimethylammonium chloride).

In various embodiments, the polyacrylamide polymer has two or more repeating units wherein at least one repeating unit is or includes an acrylamide residue and also has one or more repeating units that is an anionic group to form an anionic polyacrylamide (APAM). Non-limiting examples of anionic groups include acrylate, styrenesulfonate, lignosulfonate, carboxymethyl cellulose, etc. In various embodiments, the APAM has a repeating unit that is an anionically modified acrylamide, e.g. sulfonated acrylamide, phosphonated acrylamide, carboxylated acrylamide, polyacrylic, etc. The cationic group may be charge balanced with a positively charged counter ion, e.g. sodium ion, potassium ion, ammonium ion, calcium ion, etc. In various embodiments, the adhesive polymer is or includes an APAM that is poly (acrylamide-co-sodium acrylate).

In various other embodiments, the polyacrylamide polymer has a cationic group and an anionic group, each as first described above to form an amphoteric polyacrylamide (AmPAM). In various embodiments, the AmPAM is chosen from poly (acrylamide-itaconic acid-diallyl dimethyl ammonium chloride), poly (acrylamide-co-diallyldimethylammonium chloride-co-acrylic acid), poly (acrylamide-co-methacryloyloxyethyl trimethylammonium chloride-co-sodium acrylate), poly (acrylamide-co-dimethyldiallylammonium chloride-co-sodium 2-acrylamido-2-methylpropane sulfonate), and combinations thereof.

In various embodiments, the polyacrylamide is a CPAM. In other embodiments, the polyacrylamide is an APAM. In yet other embodiments, the polyacrylamide is a AmPAM. In other embodiments, the polyacrylamide is or includes a combination of CPAM, APAM, and AmPAM.

The adhesive polymer may be or include a polyamine that is a reaction product of epichlorohydrin, dimethylamine, and ethylenediamine. The epichlorohydrin, dimethylamine, and ethylenediamine may be reacted in various amounts and/or ratios. Accordingly, the polyamine may have three repeating units, e.g. units derived from epichlorohydrin, dimethylamine, and ethylenediamine, and may be further described as a copolymer. The three repeating units of the polyamine may be present in any order and/or arrangement, e.g. random, alternating, block, graft, or combinations thereof, which may depend on the amount of monomer reactants and/or synthesis route. In various embodiments, the polyamine has a random arrangement. In other embodiments, the polyamine has an alternating arrangement. In other embodiments, the polyamine has a block arrangement. In yet other embodiments, the polyamine has a graft arrangement. In still other embodiments, the polyamine has various sections, each has a different arrangement as described above.

Likewise, the polyamine may have various structures, which may be known in the art as linear, branched, crosslinked, and network. The structure of the polyamine may depend on the amount of each monomer reactant and/or the synthesis route. In various embodiments, the polyamine is a linear copolymer. In other embodiments, the polyamine is a branched copolymer. In other embodiments, the polyamine is a crosslinked copolymer. In yet other embodiments, the polyamine is a network copolymer.

Referring back to the adhesive polymer, in various embodiments, the adhesive polymer is polyacrylamide. In other embodiments, the adhesive polymer is a polyamine. In yet other embodiments, the adhesive polymer is a combination of polyacrylamide and the polyamine.

Each repeating unit of the adhesive polymer may be repeated one or various times, and the adhesive polymer may have various weight average molecular weights (M_{w}). In various embodiments, the weight average M_{w} of the adhesive polymer is from about 100 to about 700 kDa. In various embodiments, the weight average molecular weight (M_{w}) of the adhesive polymer is from about 100 to about 700 kDa, about 150 to about 650 kDa, about 200 to about 600 kDa, about 250 to about 550 kDa, about 300 to about 500 kDa, about 350 to about 450 kDa, or about 350 to about 400 kDa. In other embodiments, the weight average molecular weight (M_{w}) of the adhesive polymer is from about 150 to about 250 kDa, about 160 to about 240 kDa, about 170 to about 230 kDa, about 180 to about 220 kDa, about 190 to about 210 kDa, or about 190 to about 200 kDa. In yet other embodiments, the weight average molecular weight (M_{w}) of the adhesive polymer is from about 300 to about 500 kDa, about 310 to about 490 kDa, about 320 to about 480 kDa, about 330 to about 470 kDa, about 340 to about 460 kDa, about 350 to about 450 kDa, about 360 to about 440 kDa, about 370 to about 430 kDa, about 380 to about 420 kDa, about 390 to about 410 kDa, or about 390 to about 400 kDa. In other embodiments, the weight average molecular weight (M_{w}) of the adhesive polymer is from about 350 to about 650 kDa, about 360 to about 640 kDa, about 370 to about 630 kDa, about 380 to about 620 kDa, about 390 to about 610 kDa, about 400 to about 600 kDa, about 410 to about 590 kDa, about 420 to about 580 kDa, about 430 to about 570 kDa, about 440 to about 560 kDa, about 460 to about 550 kDa, about 470 to about 540 kDa, about 480 to about 530 kDa, about 490 to about 520 kDa, or about 500 to about 510 kDa. In various non-limiting embodiments, all values and ranges of values including and between those set forth above are expressly contemplated for use herein.

The adhesive polymer may have a viscosity, e.g. when present in a solvent such as water and/or an organic solvent in various amounts, e.g. about 0.1 to about 1 wt %, about 1 to about 5 wt %, about 1 to about 10 wt %, etc. The viscosity may be measured using any method known in the art. In various embodiments, the viscosity of the adhesive polymer is measured according to ASTM D2196, at about 25° C., using a rotational (Brookfield type) viscometer, with a spindle speed of from about 4 to about 6 rpm. In various embodiments, the viscosity of the adhesive polymer measured using the aforementioned method is from about 100 to about 500 mPas. In other embodiments, the viscosity of the adhesive polymer is from about 150 to about 450 mPas, about 200 to about 400 mPas, about 250 to about 350 mPas, or about 250 to about 300 mPas. In various non-limiting embodiments, all values and ranges of values including and between those set forth above are expressly contemplated for use herein.

The adhesive polymer may have various repeating units with various charges. Accordingly, the adhesive polymer may exhibit various average surface charge densities. The charge density may be measured and/or calculated using various methods known in the art. For example, the charge density may be determined using a titration method, e.g. using a polyelectrolyte with an opposite charge to the adhesive polymer. The titration end point may be identified using various techniques, e.g. using a particle charge detector, using a color indicator such as Toluidine Blue, etc.

In various embodiments, the charge density of the adhesive polymer is from about 1 to about 10 mili-equivalent (meq) per g of the adhesive polymer. In other embodiments, the charge density of the adhesive polymer is about 1 to about 2, about 1 to about 3, about 2 to about 3, about 3 to about 4, about 2 to about 4, about 4 to about 5, about 4 to about 6, about 5 to about 6, about 5 to about 7, about 6 to about 7, about 7 to about 8, about 7 to about 9, about 8 to about 9, about 8 to about 10, or about 1 to about 8 meq per g of the adhesive polymer. In various non-limiting embodiments, all values and ranges of values including and between those set forth above are expressly contemplated for use herein.

The adhesive polymer, e.g. when present in water or an aqueous solution, can additionally exhibit various pH and may be described as acidic, neutral, or basic. The pH of the adhesive polymer may be measured using any of the methods and/or apparatus e.g, a pH meter, a conductivity meter, a pH strip, a pH indicator, etc. In various embodiments, the adhesive polymer exhibits a pH of from about 5 to about 10, about 6 to about 9, about 7 to about 8, about 6 to about 7. In other embodiments, the adhesive polymer exhibits a pH of about 5, about 5.5, about 6, about 6.5, about 7, about 7.5, about 8, about 8.5, about 9, about 9.5, or about 10. In various non-limiting embodiments, all values and ranges of values including and between those set forth above are expressly contemplated for use herein.

The adhesive polymer is present in the composition in an amount of from about 1 to about 45 wt % actives, based on a total weight of the composition. Without being bound by theory, this range of adhesive polymer can be used to attain physical properties that are desirable in paper-making processes, e.g. paper creping using a creping dryer. For example, a small amount of the adhesive polymer, e.g. less than about 1 wt % actives can lead to poor adhesion of paper products on the creping dryer, reduction of creping effect, and weakening of paper strength. In contrast, a large amount of the adhesive polymer, e.g. greater than about 45 wt % actives based on a total weight of the composition, can lead to excessive tackiness, which may lead to both operational and performance issues, such as sticking of paper products to machinery, causing paper products to become undesirably less porous and stiff, etc.

In various embodiments, the adhesive polymer is present in the composition in an amount of from about 1 to about 45 wt % actives, about 1 to about 44 wt % actives, about 2 to about 43 wt % actives, or about 3 to about 42 wt % actives, about 4 to about 41 wt % actives, about 5 to about 40 wt % actives, about 6 to about 39 wt % actives, about 7 to about 38 wt % actives, about 8 to about 37 wt % actives, about 9 to about 36 wt % actives, about 10 to about 35 wt % actives, about 11 to about 34 wt % actives, about 12 to about 33 wt % actives, about 13 to about 32 wt % actives, about 14 to about 31 wt % actives, about 15 to about 30 wt % actives, about 16 to about 29 wt % actives, about 17 to about 28 wt % actives, about 18 to about 27 wt % actives, about 19 to about 26 wt % actives, about 20 to about 25 wt % actives, about 21 to about 24 wt % actives, or about 22 to about 23 wt % actives, based on a total weight of the composition. In various non-limiting embodiments, all values and ranges of values including and between those set forth above are expressly contemplated for use herein.

### Film Modifier

The composition further includes the film modifier including the polyvinylamine (PVAM). The polyvinylamine is different from the polyamine of the adhesive polymer. The polyvinylamine may be described as a polymer having a vinylamine repeating unit. The vinylamine repeating unit may be repeated various times, and the polyvinylamine may have various weight average Mw that are not particularly limited.

In various embodiments, the polyvinylamine has a weight average M_{w} of from about 300 to about 500 kDa, about 310 to about 490 kDa, about 320 to about 480 kDa, about 330 to about 470 kDa, about 340 to about 460 kDa, about 350 to about 450 kDa, about 360 to about 440 kDa, about 370 to about 430 kDa, about 380 to about 420 kDa, about 390 to about 410 kDa, or about 400 to about 410 kDa. In various non-limiting embodiments, all values and ranges of values including and between those set forth above are expressly contemplated for use herein.

The film modifier is present in the composition in an amount of from about 0.1 to about 40 wt % actives, based on a total weight of the composition. Again, without being bound by theory, the amount of the film modifier can affect the physical properties of the composition and the performance of paper products. For example, a small amount of the film modifier, e.g. less than about 0.1 wt % actives can lead to infective creping and/or reduction of softness and flexibility. In contrast, a large amount of the film modifier, e.g. greater than about 40 wt % actives can lead to excessive tackiness, which can cause operational and performance issues, as described above.

Accordingly, in various embodiments, the film modifier is present in the composition in an amount of from about 0.1 to about 40 wt % actives, about 1 to about 30 wt % actives, about 5 to about 20 wt % actives, or about 10 to about 20 wt % actives, based on a total weight of the composition. In other embodiments, the film modifier is present in an amount of from about 0.1 to about 5 wt % actives, about 0.5 to about 4.5 wt % actives, about 1 to about 4 wt % actives, about 1.5 to about 3.5 wt % actives, about 2 to about 3 wt % actives, or about 2.5 to about 3 wt % actives, based on a total weight of the composition. In various other embodiments, the film modifier is present in an amount of form about 5 to about 20 wt % actives, about 6 to about 19 wt % actives, about 7 to about 18 wt % actives, about 8 to about 17 wt % actives, about 9 to about 16 wt % actives, about 10 to about 15 wt % actives, about 11 to about 14 wt % actives, or about 12 to about 13 wt % actives, based on a total weight of the composition. In various other embodiments, the film modifier is present in an amount of form about 20 to about 40 wt % actives, about 21 to about 39 wt % actives, about 22 to about 38 wt % actives, about 23 to about 37 wt % actives, about 24 to about 36 wt % actives, about 25 to about 35 wt % actives, about 26 to about 34 wt % actives, about 27 to about 33 wt % actives, about 28 to about 32 wt % actives, about 29 to about 31 wt %, or about 29 to about 30 wt % actives, based on a total weight of the composition. In various non-limiting embodiments, all values and ranges of values including and between those set forth above are expressly contemplated for use herein.

### Plasticizer

The composition further includes a plasticizer including a compound having two or more —OH groups. In some embodiments, the compound may be described as a diol, a triol, or a polyol. The compound having two or more —OH groups is not particularly limited and may be any known in the art. For example, the compound may have two, three, four, five, six, seven, etc. —OH groups. Non-limiting examples of compounds having two or more —OH groups include glycerol, erythritol, sorbitol, mannitol, xylitol, maltitol, a polyethylene glycol (PEG), e.g. PEG 100, PEG 200, PEG 300, PEG 400, PEG 500, etc., or combinations thereof. In various embodiments, the compound having two or more —OH groups is glycerol. In other embodiments, the compound having two or more —OH groups is sorbitol. In other embodiments, the compound having two or more —OH groups is PEG 400. In various other embodiments, the compound having two or more —OH groups is a combination of glycerol, sorbital, and PEG 400.

The plasticizer is present in the composition in an amount of from about 0.1 to about 40 wt % actives, based on a total weight of the composition. This amount of the plasticizer may be used to achieve film properties and paper performance that are desirable in making specific paper products, tissue papers, paper towels, etc. For example, a small amount, e.g. less than about 0.1 wt % may result in a composition that may become brittle when heated during paper manufacturing processes and subsequently lead to poor creping performance. However, a large amount, e.g. greater than about 40 wt % actives also cause various performance issues, e.g. weakening of adhesive strength and/or excessive tackiness, which may also lead to poor creping performance.

In various embodiments, the plasticizer is present in the composition in an amount of from about 0.1 to about 40 wt % actives, about 1 to about 30 wt % actives, about 5 to about 20 wt % actives, or about 10 to about 20 wt % actives, based on a total weight of the composition. In other embodiments, the plasticizer is present in an amount of from about 0.1 to about 5 wt % actives, about 0.5 to about 4.5 wt % actives, about 1 to about 4 wt % actives, about 1.5 to about 3.5 wt % actives, about 2 to about 3 wt % actives, or about 2.5 to about 3 wt % actives, based on a total weight of the composition. In various other embodiments, the plasticizer is present in an amount of form about 5 to about 20 wt % actives, about 6 to about 19 wt % actives, about 7 to about 18 wt % actives, about 8 to about 17 wt % actives, about 9 to about 16 wt % actives, about 10 to about 15 wt % actives, about 11 to about 14 wt % actives, or about 12 to about 13 wt % actives, based on a total weight of the composition. In various other embodiments, the plasticizer is present in an amount of form about 20 to about 40 wt % actives, about 21 to about 39 wt % actives, about 22 to about 38 wt % actives, about 23 to about 37 wt % actives, about 24 to about 36 wt % actives, about 25 to about 35 wt % actives, about 26 to about 34 wt % actives, about 27 to about 33 wt % actives, about 28 to about 32 wt % actives, about 29 to about 31 wt %, or about 29 to about 30 wt % actives, based on a total weight of the composition. In various non-limiting embodiments, all values and ranges of values including and between those set forth above are expressly contemplated for use herein.

### Additional Components

The composition may additionally include water. The water may originate from various sources, e.g. commercially obtained water, tap water, filtered water, water as a part of other components, e.g. the adhesive polymer, the film modifier, the plasticizer, etc. Typically, water is included in the composition to help attain desired viscosities for various purposes and/or create a homogeneous mixture.

The water may be present in the composition in an amount of from about 50 to about 90 wt %, based on a total weight of the composition. In various embodiments, the water is present in an amount of from about 50 to about 90 wt %, about 55 to about 85 wt %, about 60 to about 80 wt %, about 65 to about 75 wt %, or about 65 to about 70 wt %, based on a total weight of the composition. In other embodiments, the water is present in an amount of from about 61 to about 79 wt %, about 62 to about 78 wt %, about 63 to about 77 wt %, about 64 to about 76 wt %, 65 to about 75 wt %, about 66 to about 74 wt %, about 67 to about 73 wt %, about 68 to about 72 wt %, about 69 to about 71 wt %, or about 70 to about 71 wt %, based on a total weight of the composition. In other embodiment, the water is present in an amount of from about 50 to about 60, about 51 to about 59, about 52 to about 58, about 53 to about 57 wt %, about 54 to about 56 wt %, or about 54 to about 55 wt %, based on a total weight of the composition. In yet other embodiments, the water is present in an amount of from about 80 to about 90 wt %, about 81 to about 89 wt %, about 82 to about 88 wt %, about 83 to about 87 wt %, about 84 to about 86 wt %, or about 84 to about 85 wt %, based on a total weight of the agriculture composition. In various non-limiting embodiments, all values and ranges of values including and between those set forth are expressly contemplated for use therein.

The composition may additionally include, or be free of, an additional adhesive polymer, so long as the additional adhesive polymer is not PAE or PEI. The additional adhesive polymer may be any known in the art and may be synthetic or natural, modified or unmodified, homopolymer or copolymer. Non-limiting examples of additional adhesive polymers include a polyaminamide, a polyalkanolamide, a polyvinyl alcohol, a polyacrylic acid, a polymethacrylic acid, a polyethylene oxide, a polyethylene glycol, an ethylene-vinyl acetate copolymer, a hydroxyethyl cellulose, a hydroxpropyl cellulose, guar gum, starch, agar, alginic acid, chitosan, a carboxymethyl cellulose, etc. In various embodiments, one or more of the additional adhesive polymers is present in the composition in an amount of from about 0 to about 10 wt % actives, about 1 to about 9 wt % actives, about 2 to about 8 wt % actives, about 3 to about 7 wt % actives, about 4 to about 6 wt % actives, or about 5 to about 6 wt % actives, based on a total weight of the composition. In various non-limiting embodiments, all values and ranges of values including and between those set forth above are expressly contemplated for use herein.

The composition may additionally and optionally include an additional film modifier. The additional film modifier may be used to further customize physical properties and paper performance. The additional film modifier may be any known in the art, such as glycerin, latex, ethylene oxide-propylene oxide copolymers, etc. The additional film modifier may be present in a small amount, e.g. about 5 wt % actives or less, based on a total weight of the composition. In various embodiments, the additional film modifier is present in an amount of from about 0 to about 5 wt % actives, about 0.5 to about 4.5 wt %, about 1 to about 4 wt % actives, about 1.5 to about 3.5 wt % actives, about 2 to about 3 wt % actives, or about 2 to about 2.5 wt % actives, based on a total weight of the composition. In various non-limiting embodiments, all values and ranges of values including and between those set forth above are expressly contemplated for use herein.

The composition may further include, or be free of, a release agent. The release agent may be used to help release paper products during paper-making processes, e.g. releasing paper products from a creping dryer. The release agent may be any known in the art and is not particularly limited. Non-limiting examples of releasing agents include silicone, mineral oils, modified hydrocarbon oils, propylene glycol, pyrrolidone, triethanolamine, diethanolamine, dipropylene glycol, aromatic sulfonamides, etc. The release agent may also be used in a small amount, e.g. about 5 wt % actives or less. In various embodiments, the release agent is present in an amount of from about 0 to about 5 wt % actives, about 0.5 to about 4.5 wt % actives, about 1 to about 4 wt % actives, about 1.5 to about 3.5 wt % actives, about 2 to about 3 wt % actives, or about 2 to about 2.5 wt % actives, based on a total weight of the composition. In various non-limiting embodiments, all values and ranges of values including and between those set forth above are expressly contemplated for use herein.

Other additives such as a surfactant, a defoamer, etc. may additionally and optionally be included in the composition. For example, a surfactant may be used to customize the physical properties of the composition to allow for easier handling and using of the composition in paper-making processes. The surfactant may be ionic or non-ionic, synthetic or natural. Non-limiting examples of surfactants are fatty alkyl amine quaternary salts, linear alkyl sulfonates, alkyl-benzene sulfonates, trimethyl cocoammonium chloride, trimethyloleylammonium chloride, trimethylstearylammonium chloride, etc.

The additive may also be a defoamer, which may be used to reduce the forming of foams, e.g. formed in mixing steps when forming the composition, and maintain homogeneity of the composition. The defoamer may be derived from any materials known in the art. For example, the defoamer may be derived from silicone, e.g. polydimethylsiloxane (PDMS), silicone glycol copolymers, etc., from alcohols such as fatty alcohols or alkyl alcohols, from mineral or vegetable oil, etc.

The additive may be present in the composition in an amount of from about 0 to about 5 wt % actives. In various embodiments, the additive is present in an amount of from about 0 to about 5 wt % actives, about 0.5 to about 4.5 wt %, about 1 to about 4 wt % actives, about 1.5 to about 3.5 wt % actives, about 2 to about 3 wt % actives, or about 2 to about 2.5 wt % actives, based on a total weight of the composition. In various non-limiting embodiments, all values and ranges of values including and between those set forth above are expressly contemplated for use herein.

### Physical Properties

The composition may exhibit various physical properties, e.g. viscosity, pH, dry content, etc., depending on the components and amounts of each component included in the composition. The physical properties of the composition may be customized for various purposes, e.g. use as a concentrate or as a ready-to-use solution.

For example, the composition may exhibit various viscosities. Without being bound by theory, the viscosity allows the composition to be easily applied, e.g. sprayed during paper-making processes. For example, a low viscosity, e.g. less than about 10 mPas, may result in operational challenges, e.g. resulting in undesirable spray behaviors and hindering the delivery of the composition in paper-making processes. In contrast, a high viscosity, e.g. greater than 100 mPas, may result in other operational challenges such as buildups and blockages of spray systems, larger droplets of the composition formed during spraying, which may result in a heterogeneous delivery of the composition.

In various embodiments, the viscosity of the composition may vary from about 10 to about 100 mPas. The viscosity of the composition may be measured using various techniques or instruments known in the art. For example, the viscosity of the composition may be measured using a standardized method such as ASTM D2196, using a rotational (Brookfield type) viscometer, using rheometer such as Malvern Kinexus rheometer, etc. In various embodiments, the viscosity of the composition, measured by any of the aforementioned methods, is from about 10 to about 100 mPas, about 20 to about 90 mPas, about 30 to about 80 mPas, about 40 to about 70 mPas, or about 50 to about 60 mPas. In various embodiments, the viscosity of the composition is from about 80 to about 100 mPas, about 81 to about 99 mPas, about 82 to about 98 mPas, about 83 to about 97 mPas, about 84 to about 96 mPas, about 85 to about 95 mPas, about 86 to about 94 mPas, about 87 to about 93 mPas, about 88 to about 92 mPas, about 89 to about 91 mPas, or about 89 to about 90 mPas. In other embodiments, the viscosity of the composition is from about 10 to about 20 mPas, about 11 to about 19 mPas, about 12 to about 18 mPas, 13 to about 17 mPas, about 14 to about 16 mPas, or about 14 to about 15 mPas. In various non-limiting embodiments, all values and ranges of values including and between those set forth above are expressly contemplated for use herein.

Relative to pH, the composition may exhibit a pH that may be compatible with paper products, e.g. from about 5 to about 10. The pH of the composition may be measured using any method or apparatus known in the art, as first described above, e.g. using a pH meter, by performing an acid/base titration, by using a pH test strip or indicator solution, etc. In various embodiments, the composition may have a pH of from about 5 to about 10, such as a pH of 5, 5.5, 6, 6.5, 7, 7.5, 8, 8.5, 9, 9.5 or 10. In various non-limiting embodiments, all values and ranges of values including and between those set forth above are expressly contemplated for use herein.

The composition may also have a varying dry content, which may alternatively be described as a solids content. The dry content describes the amount of active components in the composition, more specifically, components different from the water and/or any organic solvent. Accordingly, the dry content includes the total amount of components such as the adhesive polymer, the film modifier, the plasticizer and any additives. A low dry content, e.g. less than about 10 wt % based on a total weight of the composition, may lead to a reduction in adhesive performance and/or inefficient creping. Conversely, a large dry content, e.g. greater than about 50 wt % based on a total weight of the composition, may lead to undesirably high tackiness and an increase in viscosity, which can cause operational challenges as previously described. In various embodiments, the composition exhibits a dry content of from about 10 to about 50 wt %, based on a total weight of the composition. In various embodiments, the dry content is from about 10 to about 50 wt %, about 15 to about 45 wt %, about 20 to about 40 wt %, about 25 to about 35 wt %, or about 25 to about 30 wt %, based on a total weight of the composition. In various non-limiting embodiments, all values and ranges of values including and between those set forth above are expressly contemplated for use herein.

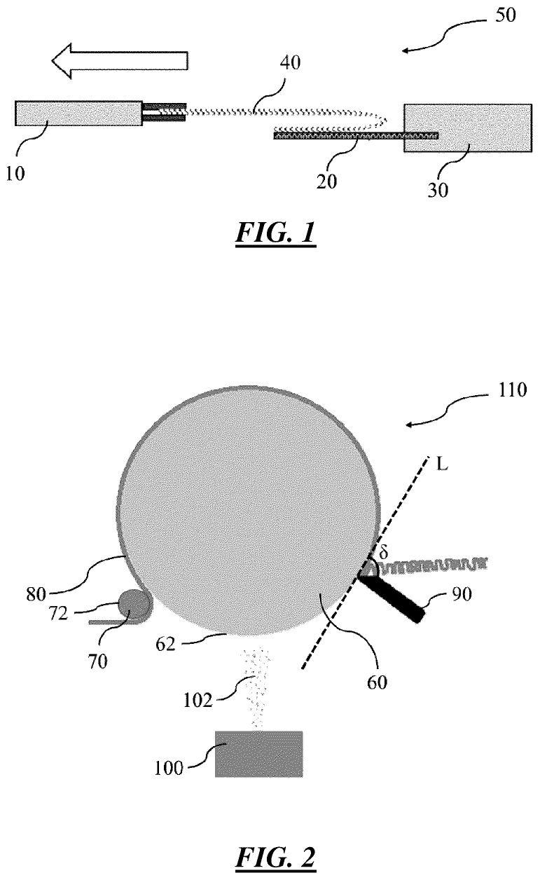

The composition may be further described using peel strength, which may be evaluated using a peel test apparatus, such as a Zwick 005. In various embodiments, the peel test apparatus (50) may be or include components as shown in FIG. 1. Various test fabrics may be used to test the peel strength of the composition. In various embodiments, a woven-fabric including 60 wt % polyether sulfone (PES), 20 wt % Viscose (CV) and 20 wt % wood pulp with dimensions of 250 mm by 25 mm, having a weight of about 50 g/m², which is categorized as a wet laid fabric (BO 505) is used as a test fabric. The composition is applied to the test fabric to form a test substrate. As shown in FIG. 1, the test substrate (40) is adhered to a metal plate (20) with a dimension of 100 mm by 25 mm. The metal plate (20) and test substrate (40) are heated to about 145° C. for about three minutes to dry and fixed to a lower clamp (30). About 20 mm of the test substrate (40) is peeled away to attach to an upper clamp (10) and expose part of the metal plate (20). The upper clamp (10) then moves at a speed of about 1000 mm/min, peeling the test substrate (40) away from the metal plate (20) in a direction indicated by the arrow. A load cell is typically attached to the upper clamp (10) to measure the force used to peel the test substrate (40) away from the metal plate (20).

In various embodiments, the composition has the peel strength, determined using the apparatus above, of from about 0.5 to about 1.6 N. In other embodiments, the composition has peel strength of from about 0.6 to about 1.5 N, about 0.7 to about 1.4 N, about 0.8 to about 1.3 N, about 0.9 to about 1.2 N, or about 1 to about 1.1 N. In various non-limiting embodiments, all values and ranges of values including and between those set forth above are expressly contemplated for use herein.

### Method of Forming the Composition

This disclosure also provides a method of forming the composition. The method includes the steps of a) providing the adhesive polymer, b) providing the film modifier, c) providing the plasticizer, and d) combining the adhesive polymer, the film modifier and the plasticizer to form the composition.

The step of providing the adhesive polymer may be any known in the art. For example, the adhesive polymer may be procured from an in-house (internal) and/or external source, in a solid or liquid form. Additionally, the step of providing the adhesive polymer may further include the step of synthesizing the adhesive polymer, which may be achieved using any method known in the art. For example, the adhesive polymer may be synthesized using any chemical reaction, e.g. an addition polymerization, a condensation polymerization, a free radical crosslinking, a vulcanization of rubber, a photocrosslinking, etc., which may or may not occur in the presence of a catalyst, e.g. a transition metal compound, an organometallic compound, a free radical initiator such as a peroxide, etc.

The adhesive polymer may be synthesized using any reactants and/or crosslinkers known in the art. Non-limiting examples of reactants and crosslinkers include acrylamide, epichlorohydrin, dimethylamine, ethylenediamine, diallyldimethylammonium chloride, dimethylaminoethyl acrylate, dimethylaminoethyl methacrylate, acryloyloxyethyl trimethylammonium chloride, methacryloyloxyethyl trimethylammonium chloride, sodium acrylate, acrylic acid, sodium styrenesulfonate, lignosulfonate, sodium carboxymethyl cellulose, etc. The adhesive polymer may further be isolated or purified using various techniques known in the art, e.g. distillation, centrifugation, dialysis, chromatographic techniques, etc.

The step of providing the adhesive polymer may further include a step of otherwise preparing the adhesive polymer to be combined with other components, e.g. dissolving the adhesive polymer in water, diluting the adhesive polymer, heating the adhesive polymer, etc.

Relative to the step of providing the film modifier, the film modifier may be provided from an in-house (internal) and/or external source. Additionally, the step of providing the film modifier may further include the step of synthesizing the film modifier, which may be achieved using any method and/or chemical reaction known in the art. In various embodiments, the film modifier is formed using a free radical polymerization reaction of vinylformamide followed by a hydrolysis step. In other embodiments, the film modifier is formed by direct polymerization of protected vinylamine monomers. In other embodiments, the film modifier is formed by polymerizing vinyl acetates followed by an ammonolysis step. The resulting film modifier may be further isolated or purified using various techniques as first described above.

The step of providing the plasticizer may be any known in the art. The plasticizer may also be obtained from an in-house (internal) and/or external source, in a solid or liquid form. The step of providing the plasticizer may further include a step of preparing the plasticizer to be combined with other components, e.g. dissolving the plasticizer in water, diluting the plasticizer, heating the plasticizer, etc.

The step of combining is not particularly limited and may be any known in the art. The step of combining may be batch or continuous, and/or may include one or more steps. Additionally, additives such as the surfactant and/or the defoamer may also be combined. The adhesive polymer, the film modifier, the plasticizer, and any additive may be combined in whole or in part. The step of combining may be performed using any known method or apparatus in the art e.g. a disperser, a mixer, a blender, a mill, a tank, a vessel, etc. The step of combining may occur in an open or closed system, with or without agitation. One skilled in the art may choose an appropriate method of combining based on specific components in the composition and desired performance.

The step of combining may be performed in any amount and/or ratio of each component so long as the adhesive polymer is present in an amount of from about 1 to about 45 wt % actives, the film modifier is present in an amount of from about 0.1 to about 40 wt % actives, and the plasticizes is present in an amount of from about 0.1 to about 40 wt %, each based on a total weight of the composition.

### Method of Creping a Fibrous Web

The composition may be used in various paper-making processes. For example, the composition may be used for creping fibrous webs. Creping may be used for various purposes, e.g. to effectively dry fibrous webs, impart softness and/or paper strength to fibrous webs, increase the volume of fibrous webs, etc. The method of creping the fibrous web include the steps of a) providing a creping dryer including a creping cylinder that has a surface, b) providing the fibrous web, c) providing the composition, d) applying the composition to the surface of the creping cylinder, c) contacting the fibrous web and the surface of the creping cylinder such that the fibrous web adheres to the surface of the creping cylinder, and f) removing the fibrous web from the surface of the creping cylinder with a doctor blade to crepe the fibrous web.

The step of providing a creping dryer may be or include the step of commercially obtaining a creping dryer, assembling a creping dryer, installing a creping dryer, attaching a creping cylinder to a creping dryer, etc. A combination of the aforementioned steps may also be performed. Additionally, the step of providing the creping dryer may further include the step of preparing the creping dryer for creping, e.g. setting appropriate parameters such as temperature, speed, etc., calibrating the creping dryer, cleaning components of the creping dryer, etc.

The creping dryer, which may be described herein simply as the “dryer”. The dryer may be any known in the art and may have various components and arrangements. In various embodiments, the dryer is a Yankee dryer. In other embodiments, the Yankee dryer includes components, such as those shown in FIG. 2. In FIG. 2, the dryer (110) includes a creping cylinder (60) which has a surface (62).

The surface (62) of the creping cylinder (60) may be made from any material known in the art. Typically, the surface (62) of the creping cylinder (60) is or includes a metal, e.g. cast iron, steel, etc. The surface (62) of the creping cylinder (60) may or may not be further coated, e.g. to improve performance and longevity of the creping cylinder (60). In various embodiments, the surface (62) of the creping cylinder (60) is coated with chrome.

The step of providing the creping dryer (60) may further include a step of cleaning the surface (62) of the creping cylinder (60). The surface (62) may be cleaned using various methods, e.g. using a wipe, a cloth, a sponge, scraped with a cleaning blade, etc.

The step of providing the fibrous web may be any known in the art. The fibrous web (80) may be additionally described as a paper web, a paper, a web, a pulp fiber, a fabric, a tissue paper, a toilet paper, a paper towel, a paper product, etc. Depending on desired paper performance and end use, e.g. as a tissue paper, a toilet paper or a paper towel, the fibrous web (80) may be formed from various materials. For example, the fibrous web (80) may be formed from softwood and/or hardwood, from virgin pulps and/or recycled pulps, etc. The fibrous web (80) may exhibit various grammages, typically from about 10 to about 100 g/m². In various embodiments, the fibrous web (80) has a grammage of from about 10 to about 100 g/m², about 20 to about 90 g/m², about 30 to about 80 g/m², about 40 to about 70 g/m², or about 50 to about 60 g/m². In various non-limiting embodiments, all values and ranges of values including and between those set forth above are expressly contemplated for use herein.

The fibrous web (80) may also be described using a ratio of wet tensile strength to dry tensile strength. A greater ratio of wet tensile strength to dry tensile strength, e.g. about 50:50 and greater, typically describes more durable and less likely to disintegrate paper products. A smaller ratio of wet tensile strength to dry tensile strength, e.g. less than about 50:50, typically describes paper products that are easy to break down, which may have other benefits, e.g. are more environmentally friendly. In various embodiments, the ratio of wet tensile strength to dry tensile strength is from about 10:90 to about 90:10, from about 20:80 to about 80:20, from about 30:70 to about 70:30, from about 40:60 to about 60:40, or from about 40:60 to about 50:50. In various non-limiting embodiments, all values and ranges of values including and between those set forth above are expressly contemplated for use herein.

The step of providing the fibrous web (80) may further include a step of otherwise preparing the fibrous web (80) before using the creping dryer, e.g. pre-drying. Pre-drying of the fibrous web (80) may be performed to remove excess moisture previously introduced to the fibrous web (80) in various manufacturing processes. Pre-drying may be beneficial to incorporate in paper-making processes to effectively remove excess moisture and allow the dryer to operate at a lower temperature, which can increase longevity of the dryer, and reduce energy consumed in paper-making processes. Pre-drying may be performed using any equipment and/or technique known in the art, e.g. mechanical pressing, infrared drying, air drying, vacuum-assisted dewatering, through air drying (TAD), etc.

Relative to the step of providing the composition, this step may be performed using any method, apparatus and/or tool known in the art. The step of providing the composition may further include a step of preparing the composition to use in creping processes, e.g. diluting the composition, mixing the composition, etc. The step of providing the composition may further include a step of introducing the composition to a creping system, e.g. pouring the composition into a holding tank, introducing the composition through capillary action, through pressure-driven mechanisms, using a pump, etc.

The method of creping the fibrous web (80) additionally includes the step of applying the composition to the surface (62) of the creping cylinder (60). The step of applying the composition may be performed using any method or tool known in the art, e.g. by directly pouring the composition onto the surface (62) of the creping cylinder (60), by using a brush, a cloth, a spatula, etc., by spraying the composition, etc. In various embodiments, the composition is applied to the surface (62) of the creping cylinder (60) by spraying using a spray boom.

As shown in FIG. 2, the composition may be sprayed with the spray boom (100) to create droplets (102) of the composition. The droplets (102) may have various droplet sizes, e.g. 1 to about 500 microns. Without being bound by theory, droplets (102) of smaller sizes, e.g. less than about 10 microns, can dry more easily and therefore, can enhance drying efficiency. However, droplets (102) of larger sizes, e.g. at least 10 microns, can penetrate the fibrous webs (80) more easily and can help enhance certain paper performance, e.g. softness and/or paper strength. The size of the droplets (102) may be measured using any method known in the art. For example, the size of the droplets may be measured using laser diffraction, photon correlation spectroscopy, Image Analysis VisiSizer technique, phase Doppler particle analysis, etc. The size of the droplets (102) may be in a monodispersed or polydisperse distribution. In various embodiments, the size of the droplets (102), which may be described as Dᵥ50, Dᵥ90,Dᵥ99, Dₙ50, Dₙ90, Dₙ99, etc., is from about 1 to about 500 microns, about 10 to about 500 microns, about 100 to about 450 microns, about 150 to about 400 microns, about 200 to about 350 microns, or about 250 to about 300 microns. In other embodiments, the size of the droplets (102) is from about 10 to about 50 microns, about 15 to about 45 microns, about 20 to about 40 microns, or about 25 to about 35 microns. In other embodiments, the size of the droplets (102) is from about 50 to about 200 microns, about 60 to about 190 microns, about 70 to about 180 microns, about 80 to about 170 microns, about 90 to about 160 microns, about 100 to about 150 microns, about 110 to about 140 microns, or about 120 to about 130 microns. In various embodiments, the size of the droplets (102) is from about 1 to about 10 microns, about 2 to about 9 microns, about 3 to about 8 microns, about 4 to about 7 microns, or about 5 to about 6 microns. In various non-limiting embodiments, all values and ranges of values including and between those set forth above are expressly contemplated for use herein.

The step of applying the composition may further include a step of heating the composition. The composition may be heated before, during, or after spraying onto the surface (62) of the creping cylinder (60). The creping cylinder (60) may be heated to various temperatures, e.g. from about 100 to about 200° C., about 120 to about 180° C., or about 140 to about 160° C., etc. Excess moisture in the composition on the surface (62) of the creping cylinder (60) may be removed during and/or after the step of heating, which can cause the composition to form a thin film on the surface (62) of the creping cylinder (60).

The method of creping the fibrous web (80) further includes the step of contacting the fibrous web (80) and the surface (62) of the creping cylinder (60). The step of contacting may be any known in the art and is not particularly limited. For example, the step of contacting may be performed manually, or as a built-in step in a paper-making process, e.g. using a transfer felt, a pick-up felt, various rolling parts, etc. In various embodiments, the step of contacting is performed with a press roll (70), as shown in FIG. 2. In various embodiments, the fibrous web (80) is placed on and in direct contact with a surface (72) of the press roll (70) such that the fibrous web (80) is positioned in between and in direct contact with both the surface (72) of the press roll (70) and the surface (62) of the creping cylinder (60). The surface (72) of the press roll (70) which is in contact with the fibrous web (80) is then compressed against the surface (62) of the creping cylinder (60) to adhere the fibrous web (80) to the surface (62) of the creping cylinder (60). The compression applied by the press roll (70) against the creping cylinder (60) can also help removing excess moisture from the fibrous web (80) and improve drying efficiency. Additionally, this compression may further improve the uniformity and softness of paper products, e.g. by smoothening paper surface and/or uniformly transferring the fibrous web (80) to the surface (62) of the creping dryer (60).

The force of the compression applied by the press roll (70) against the creping cylinder (60) can be described using nip load. The nip load used in Yankee dryers is typically from about 50 to about 150 kN/m. In various embodiments, the nip load is from about 50 to about 150 kN/m, about 60 to about 140 kN/m, about 70 to about 130 kN/m, about 80 to about 120 kN/m, about 90 to about 110 kN/m, or about 90 to about 100 kN/m. In various non-limiting embodiments, all values and ranges of values including and between those set forth above are expressly contemplated for use herein.

The step of contacting may further include a step of heating the fibrous web. The fibrous web may be heated before, during, or after adhering onto the surface (62) of the creping cylinder (60). As first described above, the creping cylinder (60) may be heated to various temperatures, e.g. from about 100 to about 200° C., about 120 to about 180° C., or about 140 to about 160° C., etc. In various non-limiting embodiments, all values and ranges of values including and between those set forth above are expressly contemplated for use herein. Excess moisture in the fibrous web may be removed during and/or after the step of heating, which may be desirable for forming final paper products.

The method of creping the fibrous web (80) additionally includes the step of removing the fibrous web (80) from the surface (62) of the creping cylinder (60), e.g. with a doctor blade (90). However, a doctor blade is not required and another appropriate implement chosen by a person of skill in the art may be used. In FIG. 2, the doctor blade (90) is positioned against the surface (62) of the creping cylinder (60). As the creping cylinder (60) rotates, e.g. clockwise in FIG. 2, the doctor blade (90) scrapes the fibrous web (80) off the surface (62) of the creping cylinder (60). This action can introduce macrofolds and/or microfolds into the fibrous web (80) to create a creped texture.

Various metrics may be used to describe creping performance, e.g. crepe ratio, pocket angle, etc. For example, the creping ratio describes how much the fibrous web (80) is stretched and creped with respect to its original length. Typically, the creping ratio is calculated using a Yankee speed and a reel speed and may be expressed as a percentage. In various embodiments, the creping ratio is from about 10 to about 40%. In other embodiments, the creping ratio is from about 12 to about 38%, about 14 to about 36%, about 16 to about 34%, about 18 to about 32%, about 18 to about 30%, about 20 to about 28%, about 22 to about 26%, or about 22 to about 24%. In various non-limiting embodiments, all values and ranges of values including and between those set forth above are expressly contemplated for use herein.

Pocket angle can be used to describe the position of the doctor blade (90) relative to the surface (62) of the creping cylinder (60). Different pocket angles can result in different microfolds and macrofolds, which may affect various film properties and paper performance. In FIG. 2, the pocket angle (δ) is formed between a tangent line (L) to the surface (62) of the creping cylinder (60) and the doctor blade (90). The pocket angle (δ) is typically from about 60 to about 100 degrees, depending on the type of paper products. In various embodiments, the pocket angle (δ) is from about 60 to about 100 degrees, about 65 to about 95 degrees, about 70 to about 90 degrees, about 75 to about 85 degrees, or about 75 to about 80 degrees. In various non-limiting embodiments, all values and ranges of values including and between those set forth above are expressly contemplated for use herein.

### EXAMPLES

Various compositions are formed using the components listed in Table 1.

TABLE 1
Chemical Components

| | | | Charge | Molecular |
|---|---|---|---|---|
| Compo- | | | Density | Weight |
| nent | Chemical Name | Type | (meq/g) | (kDa) |
| A | poly (acrylamide-co- | CPAM | 1.70 | 150 to 250 |
| | diallyldimethylammonium | | | |
| | chloride) | | | |
| B | poly (acrylamide-co- | APAM | 4.18 | 300 to 500 |
| | sodium acrylate) | | | |
| C | polyvinylamine | — | 7.50 | 300 to 500 |
| D | poly (epichlorohydrin-co- | Polyamine | 7.22 | 350 to 650 |
| | dimethylamine-co- | | | |
| | ethylenediamine) | | | |
| E | Glycerol | Triol | — | — |
| F | Sorbitol | Polyol | — | — |
| G | PEG 400 | Diol | — | — |

More specifically, Compositions 1 to 3 and CE's 4 to 20 are formed by combining the components in amounts reported in Table 2.

TABLE 2
Chemical Components and Amounts
Used in Compositions and CE's.

| Composi- | | wt % | | | | | | | |
|---|---|---|---|---|---|---|---|---|---|
| tion/CE | Component(s) | A | B | C | D | E | F | G | water |
| 1 | A + E + C | 29 | 0 | 12 | 0 | 18 | 0 | 0 | 41 |
| 2 | B + E + C | 0 | 24 | 3 | 0 | 32 | 0 | 0 | 41 |
| 3 | D + C + E | 0 | 0 | 6 | 35 | 18 | 0 | 0 | 41 |
| CE 4 | A | 59 | 0 | 0 | 0 | 0 | 0 | 0 | 41 |
| CE 5 | A + F | 47 | 0 | 0 | 0 | 0 | 12 | 0 | 41 |
| CE 6 | A + E | 47 | 0 | 0 | 0 | 12 | 0 | 0 | 41 |
| CE 7 | A + E + F | 47 | 0 | 0 | 0 | 6 | 6 | 0 | 41 |
| CE 8 | A + E + D | 29 | 0 | 0 | 12 | 18 | 0 | 0 | 41 |
| CE 9 | A + G + C | 29 | 0 | 12 | 0 | 0 | 0 | 18 | 41 |
| CE 10 | B | 0 | 6 | 0 | 0 | 0 | 0 | 0 | 41 |
| CE 11 | B + E | 0 | 47 | 0 | 0 | 12 | 0 | 0 | 41 |
| CE 12 | B + F | 0 | 47 | 0 | 0 | 0 | 12 | 0 | 41 |
| CE 13 | B + E + F | 0 | 47 | 0 | 0 | 6 | 6 | 0 | 41 |
| CE 14 | B + E + D | 0 | 29 | 0 | 18 | 12 | 0 | 0 | 41 |
| CE 15 | B + E + C | 0 | 29 | 12 | 0 | 18 | 0 | 0 | 41 |
| CE 16 | C | 0 | 0 | 59 | 0 | 0 | 0 | 0 | 41 |
| CE 17 | C + E | 0 | 0 | 41 | 0 | 18 | 0 | 0 | 41 |
| CE 18 | C + F | 0 | 0 | 41 | 0 | 18 | 0 | 0 | 41 |
| CE 19 | D | 0 | 0 | 0 | 59 | 0 | 0 | 0 | 41 |
| CE 20 | D + C + E | 0 | 0 | 24 | 18 | 18 | 0 | 0 | 41 |

Various performance metrics such as peel strength and film properties are evaluated for the compositions. The peel strength is measured using a Zwick 005 peel test apparatus as first described above. Briefly, a wet laid fabric (BO 505) woven-fabric with dimensions of 250 mm by 25 mm, having a weight of about 50 g/m², made up from 60 wt % PES, 20 wt % CV and 20 wt % wood pulp is used as a test fabric. Each composition is applied to the test fabric to form various test substrates, which are then adhered to a metal plate. The metal plate and test substrate are heated to about 145° C. for about three minutes to dry. The peel test is performed at a moving speed of about 1000 mm/min. The force used to peel each test substrate is measured and reported as peel strength in Table 3. A peel strength of from about 0.5 to about 1.6 N is considered beneficial for use as a creping adhesive.

Additionally, film properties using each composition and CE are qualitatively evaluated with respect to three parameters: softness, dry tackiness and wet tackiness. Film properties of each composition are compared against film properties of a high-performance commercial product that includes polyethyleneimine (PEI). Ratings from about 0 to about 3 are assigned to each composition, which are also reported in Table 3. Specifically, ratings of from about 2 to about 3 are considered good performance. In contrast, ratings from about 0 and up to less than about 2 are considered unsatisfactory to use in making tissues.

TABLE 3
Peel Strength and Film Properties of Compositions

| | | Film Properties | | |
|---|---|---|---|---|
| | Peel | | Dry | Wet |
| Composition/CE | Strength | Softness | tackiness | tackiness |
| 1 | 1.45 | 2 | 2 | 3 |
| 2 | 1.56 | 3 | 3 | 3 |
| 3 | 0.84 | 3 | 3 | 2 |
| CE 4 | 0.94 | 0 | 0 | 0 |
| CE 5 | 0.98 | 0.5 | 0 | 2 |
| CE 6 | 1.22 | 1.5 | 0.5 | 3 |
| CE 7 | 1.12 | 0 | 0 | 1.5 |
| CE 8 | 1.05 | 1.5 | 0.5 | 3 |
| CE 9 | 1.41 | 0 | 0 | 2.5 |
| CE 10 | 1.57 | 0 | 0 | 0 |
| CE 11 | 1.46 | 0.5 | 0 | 3 |
| CE 12 | 1.14 | 1 | 0 | 2 |
| CE 13 | 1.27 | 2.5 | 0.5 | 2 |
| CE 14 | 0.99 | 1 | 0.5 | 1 |
| CE 15 | 1.83 | 1 | 1.5 | 3 |
| CE 16 | 2.3 | 0.5 | 0 | 0 |
| CE 17 | 1.39 | 2 | 1 | 1.5 |
| CE 18 | 1.65 | 2 | 2 | 3 |
| CE 19 | 0.48 | 0.5 | 0 | 0 |
| CE 20 | 1.25 | 3 | 3 | 3 |

Compositions 1 to 3 all have a peel strength in a desired range of from about 0.5 to about 1.6 N, which can be beneficial to use as a creping adhesive. Additionally, tissue papers formed using Compositions 1 to 3 also exhibit desirable properties, e.g. ratings of 2 or higher in all three performance categories, when compared to a high-performance commercial product. In contrast, CE's 4 to 20 each fail in at least one performance category and/or the peel test.

The data shows that compositions that are free of conventional adhesive polymers, e.g. PAE and PEI, can provide performance that is comparable to and/or superior over a high-performance commercial product. Additionally, these results are also unexpected because the use of the plasticizer typically only improves softness without also improving tackiness properties. However, by combining the disclosed components in specific amounts, all three performance categories are improved, while also achieving a suitable peel strength, e.g. of from about 0.5 to about 1.6 N, allowing for the use of certain polyacrylamides and/or polyamines in creping adhesive compositions.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A creping adhesive composition comprising:
an adhesive polymer chosen from a polyacrylamide, a polyamine, and combinations thereof that is present in an amount of from about 1 to about 45 wt % actives, based on a total weight of the composition;
a film modifier comprising a polyvinylamine that is different from the polyamine and is present in an amount of from about 0.1 to about 40 wt % actives, based on a total weight of the composition; and
a plasticizer comprising a compound having two or more —OH groups that is present in an amount of from about 0.1 to about 40 wt % actives, based on a total weight of the composition;
wherein the polyamine is the reaction product of:
a. epichlorohydrin
b. dimethylamine
c. ethylenediamine; and
wherein the composition is free of polyamidoamine-epihalohydrin (PAE) and polyethyleneimine (PEI).

2. The composition of claim 1 wherein the polyacrylamide is present and is chosen from a cationic polyacrylamide, an anionic polyacrylamide, and combinations thereof.

3. The composition of claim 2 wherein the cationic polyacrylamide is poly (acrylamide-co-diallyldimethylammonium chloride).

4. The composition of claim 2 wherein the anionic polyacrylamide is poly (acrylamide-co-sodium acrylate).

5. The composition of claim 1 wherein the adhesive polymer has a weight average molecular weight (M_{w}) of from about 100 to about 700 kDa.

6. The composition of claim 1 wherein the adhesive polymer is present in an amount of from about 2 to about 40 wt % actives, based on a total weight of the composition.

7. The composition of claim 1 wherein the film modifier has a weight average molecular weight (M_{w}) of from about 300 to about 500 kDa.

8. The composition of claim 1 wherein the film modifier is present in an amount of from about 0.5 to about 35 wt % actives, based on a total weight of the composition.

9. The composition of claim 1 wherein the compound having two or more —OH groups is chosen from glycerol, sorbitol, polyethylene glycol, and combinations thereof.

10. The composition of claim 1 wherein the plasticizer is glycerol.

11. The composition of claim 1 wherein the plasticizer is present in an amount of from about 2 to about 35 wt % actives, based on a total weight of the composition.

12. The composition of claim 1 further comprising water.

13. The composition of claim 1 having a dry content of from about 10 to about 50 wt %, based on a total weight of the composition.

14. The composition of claim 1 having a pH of from about 5 to about 10.

15. The composition of claim 1 exhibiting a viscosity of from about 10 to about 100 mPas, measured according to ASTM-D1084 and/or having a peel strength of from about 0.5 to about 1.6 N.

16. The composition of claim 1 wherein
the adhesive polymer is present in an amount of from about 20 to about 40 wt % actives, based on a total weight of the composition;
the film modifier is present in an amount of from about 2 to about 15 wt % actives, based on a total weight of the composition; and
the plasticizer is present in an amount of from about 15 to about 35 wt % actives, based on a total weight of the composition.

17. The composition of claim 1 wherein:
the adhesive polymer has a weight average molecular weight (M_{w}) of from about 100 to about 700 kDa and comprises;
the polyacrylamide which comprises poly (acrylamide-co-diallyldimethylammonium chloride) or (acrylamide-co-sodium acrylate); or
the polyamine;
the adhesive polymer is present in an amount of from about 24 to about 35 wt % actives, based on a total weight of the composition;
the film modifier has a weight average molecular weight (M_{w}) of from about 300 to about 500 kDa and is present in an amount of from about 3 to about 12 wt % actives, based on a total weight of the composition; and
the plasticizer is glycerol and is present in an amount of from about 18 to about 32 wt % actives, based on a total weight of the composition.

18. A method of forming a creping adhesive composition, said method comprising the steps of:
a) providing an adhesive polymer chosen from a polyacrylamide, a polyamine, and combinations thereof,
b) providing a film modifier comprising a polyvinylamine,
c) providing a plasticizer comprising a compound having two or more —OH groups,
d) combining the adhesive polymer, the film modifier and the plasticizer to form the creping adhesive composition such that the adhesive polymer is present in an amount of from about 1 to about 45 wt % actives, the film modifier is present in an amount of from about 0.1 to about 40 wt % actives, and the plasticizes is present in an amount of from about 0.1 to about 40 wt % actives, each based on a total weight of the composition;
wherein the polyamine is the reaction product of:
a. epichlorohydrin
b. dimethylamine
c. ethylenediamine; and
wherein the composition is free of polyamidoamine-epihalohydrin (PAE) and polyethyleneimine (PEI).

19. A method for creping a fibrous web, said method comprising the steps of:
a) providing a creping dryer comprising a creping cylinder that has a surface;
b) providing a fibrous web;
c) providing a creping adhesive composition comprising:
an adhesive polymer chosen from a polyacrylamide, a polyamine, and combinations thereof and present in an amount of from about 1 to about 45 wt % actives, based on a total weight of the composition,
a film modifier comprising a polyvinylamine and present in an amount of from about 0.1 to about 40 wt % actives, based on a total weight of the composition, and
a plasticizer comprising a compound having two or more —OH groups and present in an amount of from about 0.1 to about 40 wt % actives, based on a total weight of the composition;
wherein the polyamine is the reaction product of:
a. epichlorohydrin
b. dimethylamine
c. ethylenediamine; and
wherein the composition is free of polyamidoamine-epihalohydrin (PAE) and polyethyleneimine (PEI);
d) applying the creping adhesive composition to the surface of the creping cylinder;
e) contacting the fibrous web and the surface of the creping cylinder; and
f) removing the fibrous web from the surface of the creping cylinder with a doctor blade to crepe the fibrous web.

20. The method of claim 19 wherein the creping dryer is a Yankee dryer.
